(19) United States
(12) Patent Application Publication
(10) Pub. No.: US 2024/0312682 A1
(43) Pub. Date: Sep. 19, 2024

(54) FERRITE CORE POWDER AND FERRITE CORE

(71) Applicant: POWER SUPPORT COMPANY LIMITED, TOKYO (JP)

(72) Inventor: KATSUSHI IGARASHI, TOKYO (JP)

(73) Assignee: POWER SUPPORT COMPANY LIMITED, TOKYO (JP)

(21) Appl. No.: 18/607,523

(22) Filed: Mar. 17, 2024

(30) Foreign Application Priority Data
Mar. 17, 2023 (JP) 2023-42679

(51) Int. Cl. H01F 1/34; C08K 3/22; C08K 11/00; H01F 27/255; H01F 27/28

(52) U.S. Cl. CPC H01F 1/344; C08K 3/22; C08K 11/00; H01F 27/255; H01F 27/28; C08K 2003/2265; C08K 2201/01

(57) ABSTRACT

[Problem] To provide a ferrite core having no rigidity.

[Solution] A band-shaped ferrite core includes: a first end portion 10 having a through hole; a second end portion 20 that passes through the through hole a plurality of times while a main body of the ferrite core is wound around a winding target; and a body portion 30 having a holding portion 40 that holds a state in which the main body of the ferrite core is wound around the winding target. The ferrite core contains: a ferrite core powder containing ferrite and a pulverized product of ore containing at least a silicon component as one of main components at a ratio of 85 wt %:15 wt % to 99 wt %:1 wt %; and a flexible resin serving as a binder of the ferrite core powder at a ratio of 40 wt %:60 wt % to 55 wt %:5 wt %.

### BACKGROUND OF THE INVENTION

### 1. Technical Field

The present invention relates to a ferrite core powder and a ferrite core, and particularly relates to a ferrite core powder to be mixed with a flexible resin and a ferrite core.

### 2. Description of the Related Art

Patent Literature 1 discloses a ferrite core having excellent electromagnetic characteristics and improved electromagnetic conductivity. A method for manufacturing this ferrite core includes a step of preparing a ferrite raw material, a step of adding a carbon material to the ferrite raw material, and a step of firing the ferrite raw material containing the carbon material to manufacture a ferrite core. Note that this ferrite has a rigid cylindrical shape, and is therefore presumed to be a standard one whose inner diameter is uniquely determined.
Patent Literature 1: paragraph (0009) of JP 2021-97198 A

### SUMMARY OF THE INVENTION

By the way, it is known that an impedance of a ferrite core is proportional to an effective cross-sectional area Ae through which a magnetic flux passes, and is inversely proportional to an effective magnetic path length Le through which a magnetic flux flows. Therefore, as an outer diameter of a cylindrical shape of the ferrite core is made larger such that the effective cross-sectional area Ae is larger, and as an inner diameter of the cylindrical shape is made smaller such that the effective magnetic path length Le is smaller, noise can be effectively removed.

However, as described above, the ferrite core described in Patent Literature 1 has a rigid cylindrical shape, and is presumed to be a standard one whose inner diameter is uniquely determined. Therefore, it is physically difficult to reduce the inner diameter of the cylindrical shape.

Therefore, in order to effectively remove noise, the outer diameter of the cylindrical shape is increased so as to increase the effective cross-sectional area Ae, but this makes the size of the ferrite core larger disadvantageously.

Therefore, an object of the present invention is to provide a ferrite core whose main body does not have rigidity, and a ferrite core powder suitable for such a ferrite core.

In order to solve the above problems, the present invention provides
a ferrite core containing a ferrite core powder and a flexible resin serving as a binder of the ferrite core powder at a ratio of 40 wt %:60 wt % to 55 wt %:5 wt %, in which
the ferrite core powder contains ferrite and a pulverized product of ore containing at least a silicon component as one of main components at a ratio of 85 wt %:15 wt % to 99 wt %:1 wt %.

Each of the ferrite and the pulverized product preferably has a primary particle size of 10 μm or less.

A main body of the ferrite core has a band shape, and can include:
a first end portion having a through hole;
a second end portion that passes through the through hole a plurality of times while the main body of the ferrite core is wound around a winding target; and
a body portion having a holding portion that holds a state in which the main body of the ferrite core is wound around the winding target.

Preferably, the holding portion has a plurality of protruding portions any of which is locked to an edge portion of the through hole, and
a pitch p between the protruding portions corresponds to a thickness T of the body portion.

Preferably, the holding portion has a plurality of protruding portions any of which is locked to an edge portion of the through hole, and
a pitch p between the protruding portions is based on the thickness T of the body portion.

In the through hole, preferably,
a distal end side cavity and one or more proximal end side cavities are adjacent to each other,
the holding portion has a plurality of protruding portions protruding from the body portion, in which any of the protruding portions is locked to an edge portion of the through hole,
a length x1 of the distal end side cavity in a longitudinal direction corresponds to a width X1 of the body portion,
a length x2 of the proximal end side cavity in the longitudinal direction corresponds to a width X2 obtained by adding a total height 2h of the protruding portion on both sides to the width X1 of the body portion, and
a length y of each of the distal end side cavity and the proximal end side cavity in a short direction corresponds to a thickness T of the body portion.

The main body of the ferrite core may be covered with a tape after being wound around the winding target.

The winding target may be an electric wiring cable.

The main body of the ferrite core may have a plate shape, and may be covered with a tape in a state of being attached to an attachment target.

Furthermore, the ferrite core powder according to an embodiment of the present invention
is used in the ferrite core, and
contains ferrite and a pulverized product of ore containing at least a silicon component as one of main components at a ratio of 85 wt %:15 wt % to 99 wt %:1 wt %.

### DETAILED DESCRIPTION

Hereinafter, an embodiment of the present invention will be described with reference to the drawings. In the drawings, similar components are denoted by the same reference numerals. Note that, in the present specification, expressions such as upper, lower, left, right, front, and back are relative and not absolute.

### First Embodiment

FIGS. 1A to 1G are explanatory diagrams of a ferrite core 100 according to a first embodiment of the present invention. FIG. 1A illustrates a plan view, FIG. 1B illustrates a left side view, FIG. 1C illustrates a right side view, FIG. 1D illustrates a front view, FIG. 1E illustrates a rear view, FIG. 1F illustrates a bottom side view, and FIG. 1G illustrates a perspective view with dimensions.

A main body of the ferrite core 100 has a band shape as illustrated in FIGS. 1A to 1G. The ferrite core 100 is suitably used for a noise filter or an electromagnetic wave shielding body in a frequency band corresponding to the type of ferrite, although an application of the ferrite core 100 is not limited to these applications.

The main body of the ferrite core 100 contains a ferrite core powder containing ferrite and a pulverized product of ore containing at least a silicon component as one of main components at a ratio of 85 wt %:15 wt % to 99 wt %:1 wt %.

There is a background that a silicon steel plate has been used before a ferrite core becomes a mainstream as a noise filter or the like, but use of the silicon steel plate has been limited for a reason such as heat generation. Nevertheless, a silicon component has a noise removing function and an electromagnetic wave shielding function, and it has been found that performance of noise removal and electromagnetic wave shielding can be improved by mixing a relatively small amount of the silicon component with ferrite as compared with a case of manufacturing a core with ferrite alone.

It is only required to manufacture the main body of the ferrite core 100, for example, by adding a ferrite core powder, a vulcanizing agent, and the like to a resin precursor (for example, silicon), then sufficiently kneading the mixture using a kneader, putting the kneaded product into a flat plate die to be an original form of the ferrite core 100, vulcanizing the mixture by pressurization and heating with a press molding machine to form a flat plate, punching the flat plate with a punching die corresponding to the ferrite core 100, and vulcanizing the pressed flat plate again in a high-temperature exhaust furnace.

A ratio between the ferrite core powder and the resin precursor can be, for example, 60 wt %:40 wt % to 40 wt %:60 wt %. In the main body of the ferrite core 100, typically, resin:ferrite:ore can be, for example, 50 wt %:45 wt %:5 wt %.

The resin functions as a binder of the ferrite core powder. It is only required to adopt a resin having fire resistance, oil resistance, or the like depending on a use environment of the ferrite core 100. As the resin, for example, a silicon-based resin, a polyimide-based resin, a polypropylene-based resin, or a polyurethane-based resin can be used, although not being limited thereto.

There are no particularly necessary characteristics and the like for the resin, and characteristics and the like of the resin are not limited, but a general-purpose resin having a hardness of 30 to 70 (for example, 50) can be used in order to obtain required flexibility. Note that a chlorine-based resin such as a vinyl chloride resin may be degraded by reacting with a mineral component of ore, and therefore it is not preferable to actively use the chlorine-based resin in manufacturing the ferrite core 100.

The ferrite only needs to be soft ferrite exhibiting soft magnetic properties. Therefore, for the ferrite, the type of magnetism (anisotropy/isotropy) does not matter, and a crystal structure does not matter. If I had to say, as the ferrite used in the present embodiment, a hexagonal ferrite such as strontium ferrite or barium ferrite is preferable, but a spinel ferrite such as manganese/nickel zinc ferrite and a garnet ferrite such as yttrium iron garnet ferrite can also be used.

In addition, the ferrite has an average primary particle size (a particle size at which accumulation is 50% with respect to all particles when a cumulative distribution is subtracted from a small particle size side for a volume with respect to a divided particle size range (channel) using a particle size distribution obtained by measurement with a laser diffraction particle size distribution measuring apparatus (for example, Microtrack manufactured by Nikkiso Co., Ltd.) of 10 μm or less.

As described above, the ore contains at least a silicon component as one of main components, but the ore used in the present embodiment contains a calcium component, a magnesium component, an aluminum component, an iron component, and the like in addition to the silicon component. Note that the average primary particle size of the ore is also 10 μm or less as measured by the above measurement method.

Table 1 presents chemical analysis results of the ferrite core powder of the present embodiment by X-ray fluorescence analysis. Although Table 1 does not describe components below 1 wt %, examples of such components include sodium, titanium, manganese, and phosphorus.

TABLE 1

| | Content |
|---|---|
| Element | (wt %) |
| Calcium component | 28.00 |
| (CaO) | |
| Silicon component (SiO₂) | 19.88 |
| Magnesium component | 15.27 |
| (MgO) | |
| Aluminum component | 4.09 |
| (Al₂O₃) | |
| Iron component (Fe₂O₃) | 2.36 |
| Potassium component | 1.15 |
| (K₂O) | |

The ferrite core 100 has a structure roughly divided into a first end portion 10, a second end portion 20, and a body portion 30 described below. The ferrite core 100 is integrally molded by the above-described manufacturing method or the like.

The first end portion 10 has a through hole 12, and thus is wider (for example, about 1.5 times to about 2 times) than the second end portion 20 and the body portion 30. A length x of the through hole 12 in a longitudinal direction corresponds to a width X of the body portion 30 (for example, 0.9X≤x≤1.1X, preferably 0.95X≤x≤1.05X), and a length y of the through hole 12 in a short direction corresponds to, for example, twice a thickness T of the body portion 30 (for example, 0.9T≤y≤1.1T, preferably 0.95T≤y≤1.05T).

Note that the through hole 12 is not limited to the form illustrated in FIGS. 1A to 1G, and for example, each of the angular portions of the four corners may have a rounded shape. This makes it possible to prevent the ferrite core 100 from being torn by application of an external force to the angular portions. In addition, a through hole 12 having a form as illustrated in FIGS. 6A to 6G described later can be adopted, and also in such a case, the through hole 12 can have a rounded shape having no angular portion.

Note that specific dimensional examples of each part of the ferrite core 100 will be described later with reference to a ferrite core 100 illustrated in FIGS. 6A to 6G, but “corresponding” in the description of dimensions in the present specification means that change to about +15% of each numerical value is possible.

The second end portion 20 is a portion that passes through the through hole 12 a plurality of times (for example, twice) while the main body of the ferrite core 100 is wound around a winding target (not illustrated) such as an electric wiring cable. Although an angular portion of the second end portion 20 is chamfered such that the second end portion 20 easily passes through the through hole 12, the second end portion 20 itself may be semicircular, for example.

The body portion 30 is a portion located between the first end portion 10 and the second end portion 20. The body portion 30 has a holding portion 40 that holds a state in which the main body of the ferrite core 100 is wound around a winding target. In the present embodiment, the holding portion 40 has a plurality of protruding portions 42 protruding from a front surface of the body portion 30. Each of the protruding portions 42 has a substantially right triangular cross section in a short direction, and the protruding portions 42 adjacent to each other are arranged with a relatively small gap (for example, a gap corresponding to the thickness T of the body portion 30).

Any one of the protruding portions 42 is locked to an edge portion of the through hole 12, and a state in which the main body of the ferrite core 100 is wound around a winding target is thereby held. A pitch p between the protruding portions 42 and a height h of each of the protruding portions 42 only need to be determined on the basis of the thickness T of the body portion 30.

The ferrite core 100 is wound around, for example, an electric wiring cable as a winding target, and the main body of the ferrite core 100 thereby has a cylindrical shape as an outline. As described above, the larger an outer diameter of the cylindrical shape and the smaller an inner diameter of the cylindrical shape, the better, from a viewpoint of an impedance of the ferrite core 100. In the present embodiment, the ferrite core 100 has a flexible band shape, and therefore can be wound around a winding target such as an electric wiring cable with a degree of freedom.

Therefore, when the ferrite core 100 is wound around a winding target in such a manner that generation of a gap between the ferrite core 100 and the winding target is prevented as much as possible, the inner diameter of the cylindrical shape can be reduced, and when the ferrite core 100 is wound twice or more around the winding target, the outer diameter of the cylindrical shape can be increased. Therefore, the ferrite core 100 can effectively remove noise.

### Second Embodiment

FIGS. 2A to 2G are explanatory diagrams of a ferrite core 100 according to a second embodiment of the present invention, and FIGS. 2A to 2G correspond to FIGS. 1A to 1G, respectively. The ferrite core 100 illustrated in FIGS. 2A to 2G is different from the ferrite core 100 illustrated in FIGS. 1A to 1G in that a holding portion 40 is formed not only on a front surface of a body portion 30 but also on a back surface thereof.

With the configuration illustrated in FIGS. 2A to 2G, it is also possible to wind the ferrite core 100 in such a manner that a protruding portion 42 on a front surface of a first winding of the ferrite core 100 and a protruding portion 42 on a back surface of a second winding of the ferrite core 100 fill irregularities, and the ferrite core 100 can have a high density when being cylindrical.

### Third Embodiment

FIGS. 3A to 3G are explanatory diagram of a ferrite core 100 according to a third embodiment of the present invention, and FIGS. 3A to 3G correspond to FIGS. 1A to 1G, respectively. The ferrite core 100 illustrated in FIGS. 3A to 3G is different from the ferrite core 100 illustrated in FIGS. 1A to 1G in that protruding portions 42 adjacent to each other are arranged with a relatively large gap (for example, a gap corresponding to twice a thickness T of a body portion 30) to form a holding portion 40.

When the holding portion 40 illustrated in FIGS. 3A to 3G is applied, even a large gap between the protruding portions 42 adjacent to each other (that is, a front surface of the body portion 30 itself) receives an edge portion of a through hole 12, which contributes to suppressing the height of the protruding portion 42. Also in this case, similarly to the ferrite core 100 illustrated in FIGS. 2A to 2G, the ferrite core 100 can have a high density when being cylindrical.

Note that in the ferrite core 100 illustrated in FIGS. 3A to 3G, the positions of both ends of each of the protruding portions 42 are inside an end surface of the body portion 30 (The length of each of the protruding portions 42 in a longitudinal direction can be, for example, 80% to 90% of a length between the end surfaces of the body portion 30.), but as illustrated in FIGS. 1A to 1G, the positions of both ends of each of the protruding portions 42 may be positions extending to the end surfaces of the body portion 30. Conversely, the positions of both ends of each of the protruding portions 42 of the ferrite core 100 illustrated in FIGS. 1A to 1G and FIGS. 2A to 2G may be those as illustrated in FIGS. 3A to 3G.

### Fourth Embodiment

FIGS. 4A to 4G are explanatory diagram of a ferrite core 100 according to a fourth embodiment of the present invention, and FIGS. 4A to 4G correspond to FIGS. 1A to 1G, respectively. The ferrite core 100 illustrated in FIGS. 4A to 4G is a hybrid of the technical ideas illustrated in FIGS. 2A to 2G and FIGS. 3A to 3G.

That is, in the ferrite core 100 illustrated in FIGS. 4A to 4G, a holding portion 40 in the form illustrated in FIGS. 3A to 3G is formed on each of a front surface of a body portion 30 and a back surface thereof. Therefore, the ferrite core 100 illustrated in FIGS. 4A to 4G has the highest density when being cylindrical among the ferrite cores 100 described above.

In addition, in the ferrite core 100 illustrated in FIGS. 4A to 4G, since protruding portions 42 adjacent to each other are arranged with a relatively large gap therebetween, when the ferrite core 100 is wound in such a manner that a protruding portion 42 on a front surface of a first winding of the ferrite core 100 and a protruding portion 42 on a back surface of a second winding of the ferrite core 100 fill irregularities, the irregularities mesh with each other and the ferrite core 100 is less likely to slip. Such an effect can also be obtained by the ferrite core 100 illustrated in FIGS. 2A to 2G, but the ferrite core 100 illustrated in FIGS. 4A to 4G can implement stronger meshing in shape.

### Fifth Embodiment

FIGS. 5A to 5G are explanatory diagram of a ferrite core 100 according to a fifth embodiment of the present invention, and FIGS. 5A to 5G correspond to FIGS. 1A to 1G, respectively. The ferrite core 100 illustrated in FIGS. 5A to 5G is different from the ferrite core 100 illustrated in FIGS. 1A to 1G in that each of protruding portions 42 has a substantially semicircular cross-sectional shape in a short direction, and a holding portion 40 has the protruding portions 42 with a relatively large gap therebetween.

When a highly viscous resin is adopted as a resin to be adopted for the main body of the ferrite core 100, fluidity in a die at the time of manufacturing is not sufficient, and there is a case where the resin does not flow to a distal end portion of the protruding portion 42. In view of this, the ferrite core 100 illustrated in FIGS. 5A to 5G changes the shape of each of the protruding portions 42 to avoid occurrence of variations in products.

Note that the holding portion 40 in which each of the protruding portions 42 has a substantially semicircular cross-sectional shape in the short direction as illustrated in FIGS. 5A to 5G can also be applied to the ferrite cores 100 illustrated in FIGS. 2A to 2G to FIGS. 4A to 4G.

### Sixth Embodiment

FIGS. 6A to 6G are explanatory diagram of a ferrite core 100 according to a sixth embodiment of the present invention, and FIGS. 6A to 6G correspond to FIGS. 1A to 1G, respectively. The ferrite core 100 illustrated in FIGS. 6A to 6G is different from the ferrite core 100 illustrated in FIGS. 1A to 1G in that holding portions 40 are formed on both side surfaces instead of a front surface of a body portion 30, and the shape of a through hole 12 is devised in association therewith.

The through hole 12 illustrated in FIGS. 6A to 6G has a protruding shape in which a distal end side cavity 12a and a proximal end side cavity 12b are adjacent to each other. A length x1 of the distal end side cavity 12a in a longitudinal direction corresponds to a width X1 of a body portion 13. A length x2 of the proximal end side cavity 12b in the longitudinal direction corresponds to a width X2 obtained by adding a total height 2h of the protruding portion 42 on both sides to the width X1 of the body portion 13. Note that a length y of each of the distal end side cavity 12a and the proximal end side cavity 12b in a short direction corresponds to a thickness T of the body portion 13.

With such dimensions, when a second end portion 20 passes through the through hole 12 a plurality of times while the main body of the ferrite core 100 is wound around a winding target, the second end portion 20 and the body portion 30 pass through the proximal end side cavity 12b without difficulty in the first time. In the second time, the second end portion 20 passes through the distal end side cavity 12a without difficulty, meanwhile, the body portion 30 passes through the distal end side cavity 12a while the protruding portion 42 slightly expands a short side of the distal end side cavity 12a, and finally, the protruding portion 42 is locked to an edge portion of the short side of the distal end side cavity 12a.

Note that the through hole 12 illustrated in FIGS. 6A to 6G illustrates an example in which the second end portion 20 passes through the through hole 12 twice while the main body of the ferrite core 100 is wound around a winding target. However, if the second end portion 20 is designed to pass through the through hole 12 three times, the length y of the proximal end side cavity 12b in the short direction only needs to correspond to twice the thickness T of the body portion 13.

Since the ferrite core 100 illustrated in FIGS. 6A to 6G can relatively reduce the volume of the protruding portion 42, the main body of the ferrite core 100 can be reduced in weight, and material cost can be suppressed accordingly.

Note that the actual dimensions of the ferrite core 100 illustrated in FIGS. 6A to 6G are as follows.
The main body of the ferrite core 100 has a total length of 110 mm, a total width (a width of the first end portion 10 having a maximum width) of 35 mm, and a thickness T of 2 mm,
the first end portion 10 has a total length of 25 mm, a length of 9.8 mm from an end thereof to the distal end side cavity 12a, a length of 20 mm from an end thereof to a position where the first end portion 10 becomes thinner toward the body portion 30, the length x1 of 20 mm, the length x2 of 24 mm, y of 2.3 mm, a total width of 35 mm, and each angular portion of 6-R5 at an end portion,
the second end portion 20 has a length (length from an end thereof to a position where inclination of the first protruding portion 42 starts) of 8 mm, a width of 20 mm, an end width of 18 mm, and each angular portion of 2-R3 at an end portion,
the body portion 30 has a length of 85 mm, a width (length X1) of 20 mm, and a thickness T of 2 mm, and
the holding portion 40 has a height h of 2 mm, a length (slope length) of 4 mm, and a pitch p of 6.25 mm in the protruding portions 42.

In addition, on the basis of the fact that the thickness T of the body portion 30 is 2 mm if a gap is theoretically not generated between a first winding and a second winding when the ferrite core 100 is wound and used, the value of 6.25 mm as the pitch p between the protruding portions 42 corresponds to, for example, about 6.28 mm which is a half of about 12.56 mm which is 2πT as the pitch p in order to enable fine locking so as not to generate the gap.

The dimensions of a ferrite core 100 of another embodiment can also be similar to the dimensions exemplified here. Since the dimensions of the ferrite core 100 vary depending on the thickness of a winding target, it should be noted that the above dimensions are merely an example.

FIG. 7 is a diagram illustrating a use example of the ferrite core 100 illustrated in FIGS. 6A to 6G. FIG. 7 illustrates a state held by the holding portion 40, obtained by causing the second end portion 20 to pass through the through hole 12 twice while winding the main body of the ferrite core 100 around an electric wiring cable 200.

Note that the ferrite core 100 can remove noise not only by being wound around a linear winding target like the electric wiring cable 200 but also by being attached to a breaker itself or a distribution board having the breaker therein. In such a case, it is also effective to form the ferrite core 100 into a plate shape and to attach the ferrite core 100 to a predetermined position of a distribution board or the like with a tape.

Note that it is preferable to wind a tape so as to cover an outer periphery of the ferrite core 100 illustrated in FIG. 7 because this contributes to prevention of detachment and prevention of loosening of the ferrite core 100 wound around the electric wiring cable 200.

The tape preferably has a function of shielding an electromagnetic wave including noise, such as aluminum. When the tape has an electromagnetic wave-shielding function, noise generated from the electric wiring cable 200 can be directed to the ferrite core 100, and there is an advantage that a noise removing effect is enhanced.

### BRIEF DESCRIPTION OF THE DRAWINGS

FIGS. 1A to 1G are explanatory diagrams of a ferrite core according to a first embodiment of the present invention;

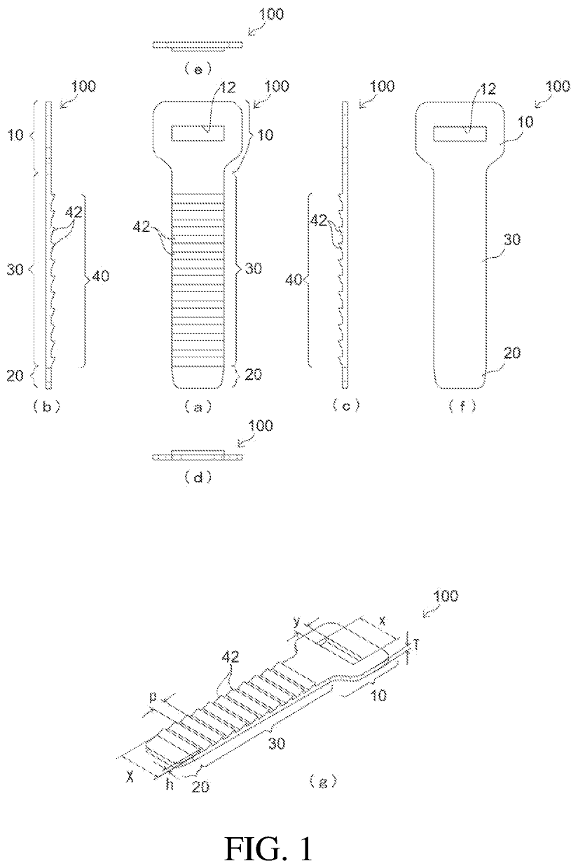

FIGS. 2A to 2G are explanatory diagrams of a ferrite core according to a second embodiment of the present invention;

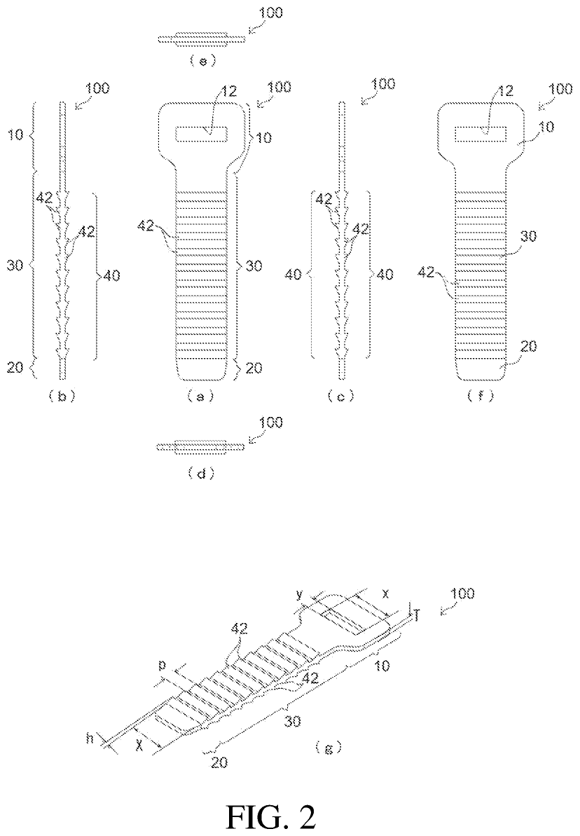

FIGS. 3A to 3G are explanatory diagrams of a ferrite core according to a third embodiment of the present invention;

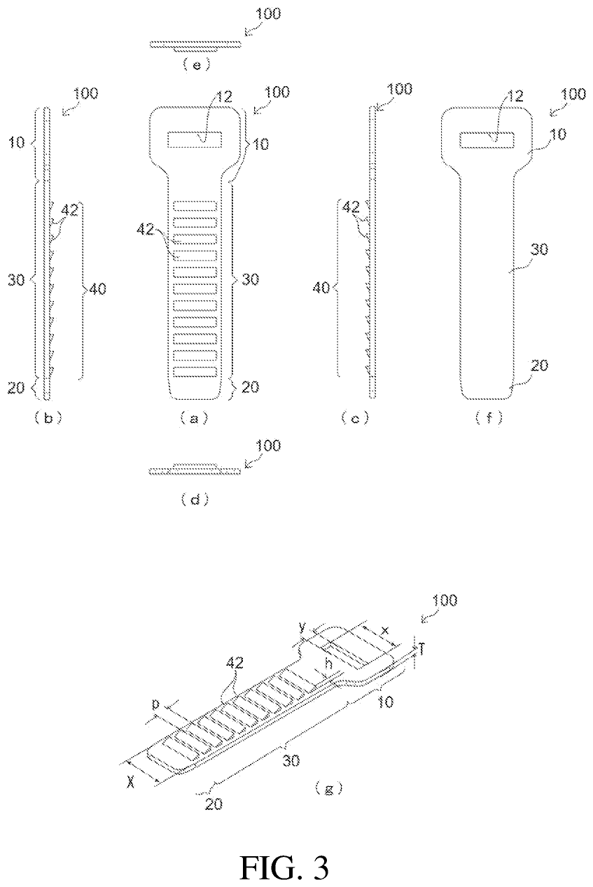

FIGS. 4A to 4G are explanatory diagrams of a ferrite core according to a fourth embodiment of the present invention;

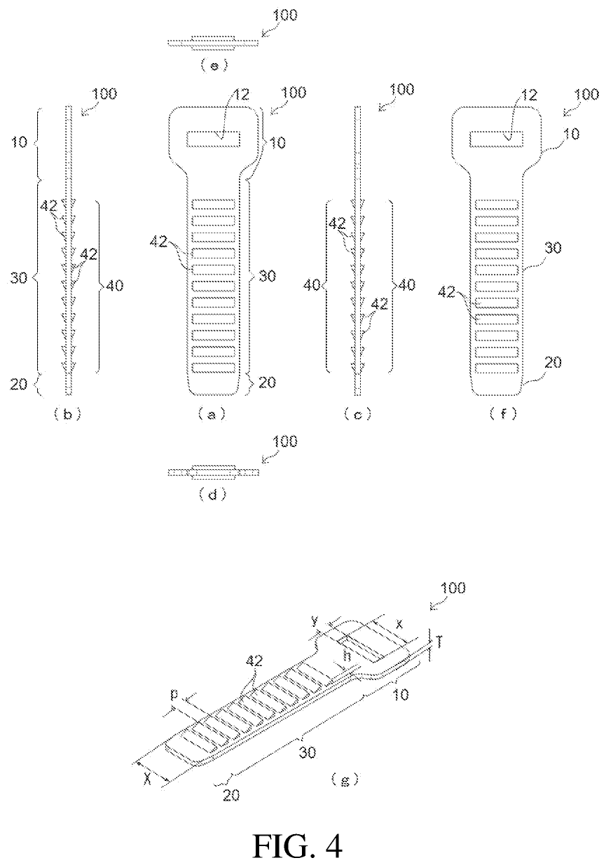

FIGS. 5A to 5G are explanatory diagrams of a ferrite core according to a fifth embodiment of the present invention;

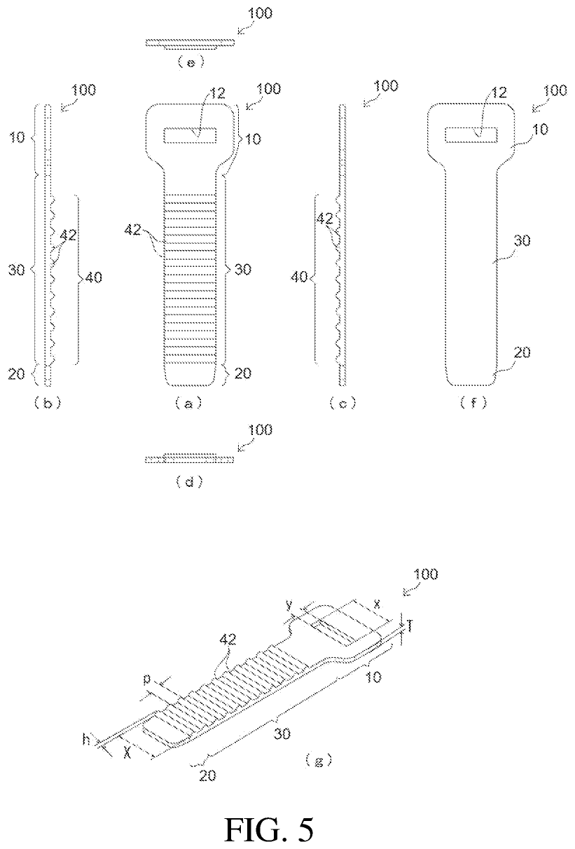

FIGS. 6A to 6G are explanatory diagrams of a ferrite core according to a sixth embodiment of the present invention; and

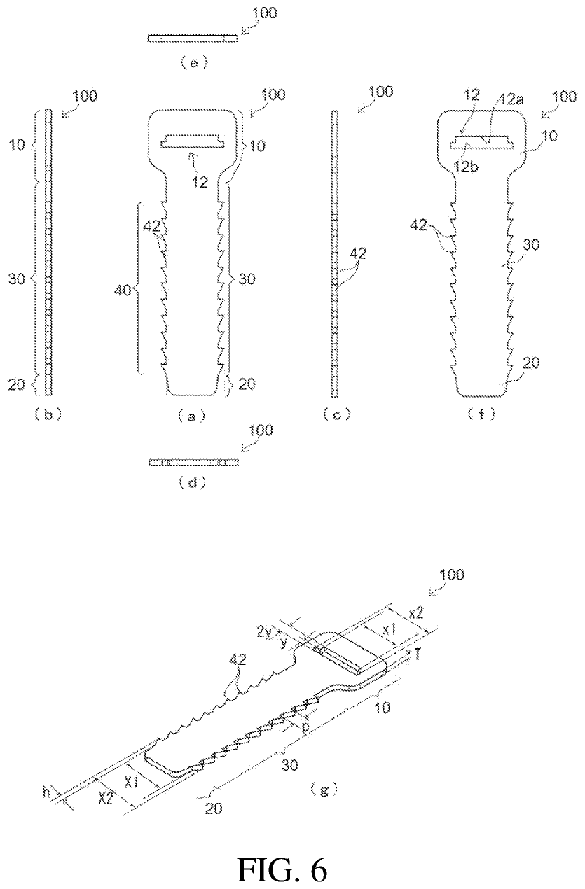

FIG. 7 is a diagram illustrating a use example of the ferrite core illustrated in FIGS. 6A to 6G.

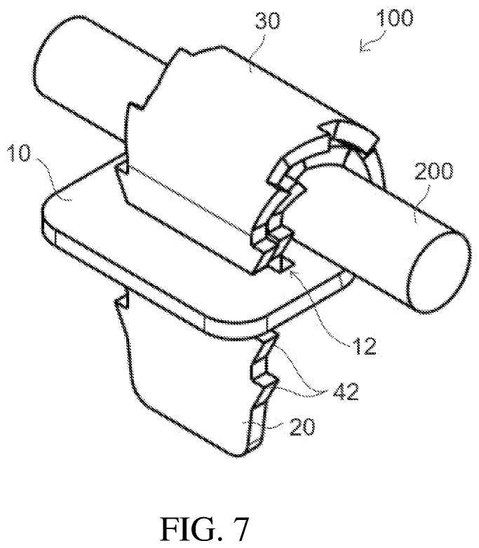

### REFERENCE SIGNS LIST

10 First end portion
12 Through hole
12a Distal end side cavity
12b Proximal end side cavity
20 Second end portion
30 Body portion
40 Holding portion
42 Protruding portion
100 Ferrite core
200 Electric wiring cable

What is claimed is:

1. A ferrite core comprising: a ferrite core powder; and a flexible resin serving as a binder of the ferrite core powder at a ratio of 40 wt %:60 wt % to 55 wt %:5 wt %, wherein
the ferrite core powder contains ferrite and a pulverized product of ore containing at least a silicon component as one of main components at a ratio of 85 wt %:15 wt % to 99 wt %:1 wt %.

2. The ferrite core according to claim 1, wherein each of the ferrite and the pulverized product has a primary particle size of 10 μm or less.

3. The ferrite core according to claim 1, wherein
a main body of the ferrite core has a band shape, and includes:
a first end portion having a through hole;
a second end portion that passes through the through hole a plurality of times while the main body of the ferrite core is wound around a winding target; and
a body portion having a holding portion that holds a state in which the main body of the ferrite core is wound around the winding target.

4. The ferrite core according to claim 3, wherein
the holding portion has a plurality of protruding portions any of which is locked to an edge portion of the through hole, and
a pitch p between the protruding portions corresponds to a thickness T of the body portion.

5. The ferrite core according to claim 3, wherein
the holding portion has a plurality of protruding portions any of which is locked to an edge portion of the through hole, and
a pitch p between the protruding portions is based on a thickness T of the body portion.

6. The ferrite core according to claim 3, wherein
in the through hole, a distal end side cavity and one or more proximal end side cavities are adjacent to each other,
the holding portion has a plurality of protruding portions protruding from the body portion, in which any of the protruding portions is locked to an edge portion of the through hole,
a length x1 of the distal end side cavity in a longitudinal direction corresponds to a width X1 of the body portion,
a length x2 of the proximal end side cavity in the longitudinal direction corresponds to a width X2 obtained by adding a total height 2h of the protruding portion on both sides to the width X1 of the body portion, and
a length y of each of the distal end side cavity and the proximal end side cavity in a short direction corresponds to a thickness T of the body portion.

7. The ferrite core according to claim 3, wherein the main body of the ferrite core is covered with a tape after being wound around the winding target.

8. The ferrite core according to claim 3, wherein the winding target is an electric wiring cable.

9. The ferrite core according to claim 1, wherein the main body of the ferrite core has a plate shape, and is covered with a tape in a state of being attached to an attachment target.

10. A ferrite core powder used in the ferrite core according to claim 1, comprising:
ferrite; and a pulverized product of ore containing at least a silicon component as one of main components at a ratio of 85 wt %:15 wt % to 99 wt %:1 wt %.
